(19) United States
(12) Patent Application Publication
(10) Pub. No.: US 2014/0256860 A1
(43) Pub. Date: Sep. 11, 2014

(54) SHORT OIL ALKYD RESIN DISPERSION FOR INDUSTRIAL COATING COMPOSITIONS

(71) Applicants: Rebecca Ortiz, Midland, MI (US); Gary Spilman, Midland, MI (US); Timothy J. Young, Bay City, MI (US); Robert W. Sandoval, Midland, MI (US)

(72) Inventors: Rebecca Ortiz, Midland, MI (US); Gary Spilman, Midland, MI (US); Timothy J. Young, Bay City, MI (US); Robert W. Sandoval, Midland, MI (US)

(73) Assignee: Dow Gloobal Technologies, LLc, Midland, MI (US)

(21) Appl. No.: 14/350,744

(22) PCT Filed: Oct. 12, 2012
(86) PCT No.: PCT/US2012/060114

§ 371 Date: Apr. 9, 2014

Related U.S. Application Data
(60) Provisional application No. 61/546,199, filed on Oct. 12, 2011.

(51) Int. Cl. C09D 167/08

(52) U.S. Cl. CPC C09D 167/08
USPC 524/100; 524/599

(57) ABSTRACT

The present disclosure provides for an aqueous solvent-free short oil alkyd resin dispersion and a process for producing the same. The aqueous solvent-free short oil alkyd resin dispersion, according to the present disclosure comprises from 35 to 65 percent by weight of a short oil alkyd resin based on the total weight of the dispersion, where the short oil alkyd resin has a weight average molecular weight (Mw) in the range of 5,000 to 5,000,000 Dalton and a volume average particle size diameter in the range of 0.05 to 1.0 μm; 0.1 to 6 percent by weight of a surfactant, based on the total weight of the dispersion; and 29 to 65 percent by weight of water, based on the total weight of the dispersion, where the aqueous solvent-free short oil alkyd resin dispersion does not include a solvent.

### FIELD OF DISCLOSURE

The present disclosure relates to a short oil alkyd resin dispersion and in particular to a short oil alkyd resin dispersion for use in industrial coatings.

### BACKGROUND OF THE DISCLOSURE

Short oil alkyd resins are a major part of the industrial coatings market. These industrial coatings, however, utilize solvents, such as volatile organic compounds (“VOC”), in their formulations. The problem is there are stringent regulations regarding the use of VOC that are putting pressure on the industrial coatings market to provide industrial coatings that are either low in or free of solvents (e.g., VOC).

Therefore, there is a need for a short oil alkyd resin dispersion that is solvent free and that is useful for the industrial coatings market.

### SUMMARY OF THE DISCLOSURE

The present disclosure provides a solution to the need for a short oil alkyd resin dispersion that is solvent free and that is useful as an industrial coating composition. Specifically, the present disclosure provides an aqueous solvent-free short oil alkyd resin dispersion that includes 35 to 65 percent by weight of a short oil alkyd resin, based on the total weight of the dispersion, where the short oil alkyd resin has a weight average molecular weight (M_{w}) in the range of 5,000 to 5,000,000 Dalton and a volume average particle size diameter in the range of 0.05 to 1.0 μm; 0.1 to 6 percent by weight of a surfactant, based on the total weight of the dispersion; and 29 to 65 percent by weight of water, based on the total weight of the dispersion, where the aqueous solvent-free short oil alkyd resin dispersion does not include a solvent. As no solvent is present in the aqueous solvent-free short oil alkyd resin dispersion, there are zero (0) volatile organic compounds in the aqueous solvent-free short oil alkyd resin dispersion.

The present disclosure also provides for a solvent-free process for producing the aqueous solvent-free short oil alkyd resin dispersion that includes emulsifying a short oil alkyd resin in water with a surfactant, in the absence of a solvent, to produce an emulsified mixture product, where both the short oil alkyd resin and the water are in a liquid state; and then cooling the emulsified mixture product to produce the aqueous solvent-free short oil alkyd resin dispersion having 35 to 65 percent by weight of the short oil alkyd resin in a solid state with a volume average particle size diameter in the range of 0.05 to 1.0 μm.

The present disclosure also provides for an industrial coating composition that includes the aqueous solvent-free short oil alkyd resin dispersion, as provided herein, and a liquid vehicle with which the aqueous solvent-free short oil alkyd resin dispersion is blended. In one embodiment, the industrial coating composition can include the aqueous solvent-free short oil alkyd resin dispersion and a metal containing drier. In an alternative embodiment, the industrial coating composition can include the aqueous solvent-free short oil alkyd resin dispersion and a melamine resin or a blocked isocyanate for curing.

The present disclosure also provides for a coating layer derived from the industrial coating composition provided herein. The present disclosure also provides for a method for producing a coating layer with the industrial coating composition that includes providing the industrial coating composition having the aqueous solvent-free short oil alkyd resin dispersion, applying the industrial coating composition to a surface; and removing at least a portion of the water from the industrial coating composition applied to the surface thereby producing a coating layer.

### BRIEF DESCRIPTION OF THE FIGURES

FIGS. 1A-1D provide photographs of coating layers derived from Industrial Coating Composition Formulation Example 1 (FIG. 1A), Industrial Coating Composition Formulation Example 2 (FIG. 1B), Comparative Example A (FIG. 1C) and Comparative Example B (FIG. 1D) after 150 hours in a salt fog cabinet.

FIG. 2 provide photographs of coating layers derived from Industrial Coating Composition Formulation Example 3 (Left), Comparative Example A (Middle), and Industrial Coating Composition Formulation Example 4 (Right) after 217 hours in a salt fog cabinet.

### DETAILED DESCRIPTION OF THE DISCLOSURE

The present disclosure provides an aqueous solvent-free short oil alkyd resin dispersion, and a solvent-free process for producing the aqueous solvent-free short oil alkyd resin dispersion. The present disclosure also provides for an industrial coating composition that includes the aqueous solvent-free short oil alkyd resin dispersion and a liquid vehicle with which the aqueous solvent-free short oil alkyd resin dispersion is blended. The present disclosure also provides for a method of producing a coating layer from the industrial coating composition, and the coating layer itself derived from the industrial coating composition.

The aqueous solvent-free short oil alkyd resin dispersion of the present disclosure provides a water based binder system useful for an industrial coating composition. This is surprising as short oil alkyd resins for this purpose are traditionally solvent based resin systems. In addition, the short oil alkyd resins of the present disclosure are not chemically modified in any way to promote their dispersion in the aqueous solvent-free dispersion of the present disclosure (e.g., no functionality is added to the short oil alkyd resin in order to promote their dispersion in an aqueous solution). In addition, embodiments of the present invention can provide for a latex type industrial coating composition, where the aqueous solvent-free short oil alkyd resin dispersion of the present disclosure does not add a solvent, such as a volatile organic compound (“VOC”), to the industrial coating composition, but which provides a coating layer having improved gloss and corrosion resistance as compared to solvent borne systems.

Short oil alkyd resins are polyesters formed by repeated esterification reactions (polycondensation) between polyhydric alcohols and di- or polybasic carboxylic acids (or their anhydrides). In the majority of cases, fatty acids or fatty-acid glycerides are co-esterified with the above mentioned components. Glycerol is a commonly used polyol, and phthalic anhydride is a commonly used dibasic acid component. The use of other polyhydric alcohols and di- or polybasic carboxylic acids (or their anhydrides) is also possible, as will be discussed herein. A monobasic carboxylic acid with a long hydrocarbon chain, i.e. a higher fatty acid, is also included with the alkyd. The weight percent of the monobasic carboxylic acid with the long hydrocarbon chain helps to define the short oil alkyd resins, where they have an oil length (fatty acid content) from less than 40 weight percent (wt. %) to 1 wt. % oil (where oil length is calculated by dividing the amount of “oil” in the final alkyd resin by the total weight of the weight of all ingredients minus water evolved in reaction, expressed as a percentage). For the various embodiments, the oil length (fatty acid content) can also be from 48 wt. % to 1 wt. % oil.

The aqueous solvent-free short oil alkyd resin dispersion, according to the present disclosure, comprises 35 to 65 percent by weight of a short oil alkyd resin based on the total weight of the dispersion, where the short oil alkyd resin has a weight average molecular weight (M_{w}) in the range of 5,000 to 5,000,000 Dalton and a volume average particle size diameter in the range of 0.05 to 1.0 μm; 0.1 to 6 percent by weight of a surfactant, based on the total weight of the dispersion and 29 to 65 percent by weight of water, based on the total weight of the dispersion, where the aqueous solvent-free short oil alkyd resin dispersion does not include a solvent. For the various embodiments, the aqueous solvent-free short oil alkyd resin dispersion does not include a solvent because no solvent(s) are used in producing the aqueous solvent-free short oil alkyd resin dispersion.

In addition, the short oil alkyd resin used in forming the aqueous solvent-free dispersion of the present disclosure is not chemically modified in any way in order to promote its dispersion in the aqueous solvent-free dispersion of the present disclosure (e.g., no functionality is added to the short oil alkyd resin in order to promote their dispersion in an aqueous solution).

The aqueous solvent-free short oil alkyd resin dispersion comprises from 35 to 65 percent by weight of a short oil alkyd resin based on the total weight of the dispersion. All individual values and subranges from 35 to 65 weight percent are included herein and disclosed herein; for example, the weight percent can be from a lower limit of 35, 40, 45 or 50, to an upper limit of 55, 60 or 65.

The short oil alkyd resin has an acid value of no greater than 20 mg of potassium hydroxide (KOH) per gram of the short oil alkyd resin. All individual values and subranges from an acid value of no greater than 20 mg of KOH per gram of the short oil alkyd resin are included herein and disclosed herein; for example, the acid value can be from a lower limit of one, 0.1, 0.5, 1, 2, 5, 7 or 10 to an upper limit of 5, 7, 10, 15, or 20. The short oil alkyd resin has a weight average molecular weight (M_{w}) in the range of 5,000 (five thousand) Dalton to 5,000,000 (five million) Dalton. It is also possible to use the short oil alkyd resin having a weight average molecular weight (M_{w}) in the range of 3,000 (three thousand) Dalton to 5,000,000 (five million) Dalton. All individual values and subranges for the weight average molecular weight (M_{w}) from 5,000 Dalton to 5,000,000 Dalton are included herein and disclosed herein; for example, the weight average molecular weight (M_{w}) can be from a lower limit of 5,000 Dalton, 10,000 Dalton, 50,000 Dalton or 1,000,000 Dalton to an upper limit of 2,000,000 Dalton, 3,000,000 Dalton, 4,000,000 Dalton or 5,000,000 Dalton. In one embodiment, the short oil alkyd resin has a weight average molecular weight (M_{w}) in the range of 1,000,000 to 5,000,000 Dalton. The weight average molecular weight (M_{w}) of the short oil alkyd resin is measured according to ASTM D5296-05, where the short oil alkyd resin of the present disclosure is used in place of the subject polystyrene in ASTM D5296-05. The standards used for the weight average molecular weight (M_{w}) measurements were the polystyrene standards recited in ASTM D5296-05.

The aqueous solvent-free short oil alkyd resin dispersion can have a viscosity in the range of 100 to 10,000 Centipoise (cP). All individual values and subranges from 100 cP to 10,000 cP; for example, the viscosity may be from a lower limit of 100, 1,000, or 2,000 cP at 18° C. to an upper limit of 3,000, 4,000, or 5,000 cP. Each viscosity is measured at room temperature (approximately 18° C.) with a Brookfield Viscometer according to ASTM D2196.

As discussed herein, short oil alkyd resins are polyesters of polyhydroxyl alcohols and polycarboxylic acids chemically combined with various drying and/or semi-drying oils in different proportions. Polyhydroxyl alcohols may include, but are not limited to, such components as ethylene glycol, diethylene glycol, neopentyl glycol, 1,4-butanediol, 1,6-hexanediol, glycerol, pentaerythritol, sorbitol and mannitol.

Suitable glycols thus include ethylene glycol, propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol, neopentyl glycol, glycerol, 1,3-propanediol, 2,4-dimethyl-2-ethyl-hexane-1,3-diol, 2,2-dimethyl-1,2-propanediol, 2-ethyl-2-butyl-1,3-propanediol, 2-ethyl-2-isobutyl-1,3-propanediol, 1,3-butanediol, 1,4-butanediol, 1,5-pentanediol, 1,6-hexanediol, 2,2,4-tetramethyl-1,6-hexanediol, thiodiethanol, 1,2-cyclohexanedimethanol, 1,3-cyclohexanedimethanol, 1,4-cyclohexanedimethanol, 2,2,4-trimethyl-1,3-pentanediol, 2,2,4-tetramethyl-1,3-cyclobutanediol, p-xylenediol, hydroxypivalyl hydroxypivalate, 1,10-decanediol, hydrogenated bisphenol A, trimethylolpropane, trimethylolethane, pentaerythritol, erythritol, threitol, dipentaerythritol, sorbitol, mannitol, glycerine, dimethylolpropionic acid, and the like.

Polycarboxylic acids may include, but are not limited to, phthalic acid, maleic acid, fumaric acid, isophthalic acid, succinic acid, adipic acid, azeleic acid, and sebacic acid, terephthalic acid, tetrachlorophthalic anhydride, tetrahydrophthalic anhydride, dodecanedioic acid, sebacic acid, azelaic acid, 1,4-cyclohexanedicarboxylic acid, 1,3-cyclohexanedicarboxylic acid, 2,6-naphthalenedicarboxylic acid, glutaric acid, trimellitic anhydride acid, benzoic acid, citric acid, pyromellitic dianhydride acid, trimesic acid, sodium sulfoisophthalic acid, as well as from anhydrides of such acids, and esters thereof, where they exist.

Drying oils may include, but are not limited to, coconut oil, fish oil, linseed oil, tong oil, castor oil, cottonseed oil, safflower oil, sunflower oil, soybean oil, canola oil, corn oil, flaxseed oil, palm oil, palm kernel oil, epoxidized soybean oil, hydrogenated castor oil, rapeseed oil, tall oil and fatty acids derived therefrom, as well as any mixture of the above oils in any ratio and blended with any fatty acid. Fatty acid blends may also be made from their purified methyl esters available commercially. These are usually from 10-30 Carbon units in length with varying amounts of unsaturation. There are also dimerized fatty acids such as those sold under the tradename Pripol by Croda.

Examples of commercially available short oil alkyd resins that might be made with the process of the present disclosure include those made commercially available by Deltech Resins Corporation.

In addition to an amount of polyol reacted with a fatty acid, fatty ester, or naturally occurring-partially saponified oil, an additional amount of a polyol or other branching agent such as a polycarboxylic acid may be used to increase the molecular weight and branching of the alkyd resin, and may be selected from trimethylolethane, pentaerythritol, erythritol, threitol, dipentaerythritol, sorbitol, glycerine, trimellitic anhydride, pyromellitic dianhydride, dimethylolpropionic acid, and trimethylolpropane.

The short oil alkyd resin may be produced, for example, by direct fusion of glycerol, phthalic anhydride and drying fatty acid. Solvents are not used in the present disclosure to reduce the viscosity. Various proportions of the polycarboxylic acid, polyhydric alcohol, and oil or fatty acid are used to obtain alkyd resins of various properties.

The short oil alkyd resin may further include one or more modifications that may help to improve various properties apart from promoting their dispersion in an aqueous solution. Such properties can include the open time, flow and/or leveling characteristics of the industrial coating compositions formed with the aqueous solvent-free short oil alkyd resin dispersion. In addition, the coating layer derived from the industrial coating composition of the present disclosure can have one or more of improved chemical resistance, scratch resistance, mar resistance, reduction in yellowing, gloss retention, humidity resistance and/or corrosion resistance due to the one or more modifications to the short oil alkyd resin. Any modifications to the short oil alkyd resins discussed herein are, however, not made to the extent that they facilitate or promote the dispersion of the short oil alkyd resin in the aqueous solvent-free short oil alkyd resin dispersion. Examples of such modifications are discussed in the following five paragraphs. Other modifications, however, are also possible.

Examples of such modifications can include, for example, modifying the short oil alkyd resin with urethane, acrylic, styrene, vinyl ester, vinyl ether, silicone, epoxy, combinations thereof, and the like. The short oil alkyd resin may also, for example, be one or more uralkyds, i.e. urethane modified alkyd. The uralkyd may be prepared by reacting alkyds having isocyanate-reactive groups with mono-, di-, or polyisocyanates and optionally other components having isocyanate-reactive groups. Isocyanate-reactive groups are defined as groups which will react with an isocyanate group (—NCO) and examples include—OH, —NH₂, —NH—, and —SH. Preferred isocyanate-reactive groups are —OH.

Examples of suitable polyisocyanate(s), (normally diisocyanate(s)) include aliphatic and cycloaliphatic polyisocyanates such as ethylene diisocyanate, 1,6-hexamethylene diisocyanate HDI, isophorone diisocyanate (IPDI), cyclohexane-1,4-diisocyanate, 4,4′-dicyclohexylmethane diisocyanate, cyclopentylene diisocyanate, p-tetra-methylxylene diisocyanate (p-TMXDI) and its meta isomer (m-TMXDI), hydrogenated 2,4-toluene diisocyanate and hydrogenated 2,6-toluene diisocyanate. Also araliphatic and aromatic polyisocyanates may be used, such as p-xylene diisocyanate, 1,4-phenylene diisocyanate, 2,4-toluene diisocyanate, 2,6-toluene diisocyanate, 4,4′-diphenylmethane diisocyanate, 2,4′-diphenylmethane diisocyanate and 1,5-naphthylene diisocyanate. Particularly preferred is 2,4-toluene diisocyanate (TDI), optionally in admixture with its 2,6-isomer.

Examples of suitable polyols for use in preparation of uralkyds include difunctional alcohols, trifunctional alcohols (e.g., glycerine, trimethylol propane, trimethylol ethane, trimethylol butane, tris hydroxyethyl isocyanurate, etc.), tetrahydric or higher alcohols (e.g., pentaerythritol, diglycerol, etc.), and combinations thereof. Trifunctional alcohols are preferred due to the degree of branching they allow. Difunctional alcohols (or diols), if used, are preferably used in combination with trifunctional or higher alcohols. Examples of suitable diols include neopentyl glycol (NPG), ethylene glycol, propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol, 1,3-propanediol, 2,4-dimethyl-2-ethyl-hexane-1,3-diol, 2,2-dimethyl-1,2-propanediol, 2-ethyl-2-butyl-1,3-propanediol, 2-ethyl-2-isobutyl-1,3-propanediol, 1,3-butanediol, 1,4-butanediol, 1,5-pentanediol, 1,6-hexanediol, 2,2,4-tetramethyl-1,6-hexanediol, thiodiethanol, 1,2-cyclohexanedimethanol, 1,3-cyclohexane-dimethanol, 1,4-cyclohexanedimethanol, 2,2,4-trimethyl-1,3-pentanediol, 2,2,4-tetramethyl-1,3-cyclobutanediol, p-xylenediol, hydroxypivalylhydroxypivalate, 1,10-decanediol, and hydrogenated bisphenol A.

The reaction mixture for producing the short oil alkyd resin includes one or more aliphatic or aromatic polycarboxylic acids, esterified polymerization products thereof, and combinations thereof. As used herein, the term “polycarboxylic acid” includes both polycarboxylic acids and anhydrides thereof. Examples of suitable polycarboxylic acids for use in the present disclosure include phthalic acid, isophthalic acid, terephthalic acid, tetrahydrophthalic acid, naphthalene dicarboxylic acid, and anhydrides and combinations thereof.

Mixtures of polyisocyanates can be used and also polyisocyanates which have been modified by the introduction of urethane, allophanate, urea, biuret, carbodiimide, uretonimine or isocyanurate residues. The short oil alkyd may also include, for example, ionic groups such as anionic carboxylic acid groups, and/or non-ionic groups such as polyethylene oxide (PEO) chain groups.

The short oil alkyd resin may be partially or fully neutralized with a neutralizing agent. In certain embodiments, neutralization of the short oil alkyd resin may be from 5 to 200 percent on a molar basis; or in the alternative, it may be from 25 to 100 percent on a molar basis. The neutralizing agent may be a base, such as ammonium hydroxide or potassium hydroxide, for example. Other neutralizing agents can include lithium hydroxide or sodium hydroxide, for example. In another alternative, the neutralizing agent may, for example, be a carbonate. In another alternative, the neutralizing agent may, for example, be any amine such as monoethanolamine, or 2-amino-2-methyl-1-propanol (AMP). Amines useful in embodiments disclosed herein may include monoethanolamine, diethanolamine, triethanolamine, and TRIS AMINO (each available from Angus), NEUTROL TE (available from BASF), as well as triisopropanolamine, diisopropanolamine, and N,N-dimethylethanolamine (each available from The Dow Chemical Company, Midland, Mich.). Other useful amines may include ammonia, monomethylamine, dimethylamine, trimethylamine, monoethylamine, diethylamine, triethylamine, mono-n-propylamine, dimethyl-n propylamine, N-methanol amine, N-aminoethylethanolamine, N-methyldiethanolamine, monoisopropanolamine, N,N-dimethyl propanolamine, 2-amino-2-methyl-1-propanol, tris(hydroxymethyl)-aminomethane, N,N,N′N′-tetrakis(2-hydroxylpropyl)ethylenediamine, 1.2-diaminopropane. In some embodiments, mixtures of amines or mixtures of amines with bases may be used. Those having ordinary skill in the art will appreciate that the selection of an appropriate neutralizing agent depends on the specific composition formulated, and that such a choice is within the knowledge of those of ordinary skill in the art.

The aqueous solvent-free short oil alkyd resin dispersion includes 0.1 to 6 percent by weight of a surfactant, based on the total weight of the dispersion. All individual values and subranges from 0.1 to 6 percent by weight of the surfactant are included herein and disclosed herein; for example, the weight percent can be from a lower limit of 0.1, 0.2, 0.5, 1 or 2 weight percent to an upper limit of 2, 3, 4, 5, or 6. In one embodiment, the aqueous solvent-free short oil alkyd resin dispersion has 2 to 4 percent by weight of the surfactant, based on the total weight of the dispersion.

In addition to being both aqueous and solvent free, the aqueous solvent-free short oil alkyd resin dispersion of the present disclosure also utilizes less surfactant than is typically used with conventional short oil alkyd resin dispersions. These values for the conventional short oil alkyd dispersions are typically greater than 6 percent up to 10 weight percent based on the total weight of the dispersion. Using less surfactant in the aqueous solvent-free short oil alkyd resin dispersion of the present disclosure is beneficial because surfactant tends to “wash out” of the coatings formed with the short oil alkyd resin dispersion over time. This “wash out” can leave holes or vacancies in the coating that can permit water to penetrate to the underlying metal and cause oxidation (e.g., rust). As such, using less surfactant in the aqueous solvent-free short oil alkyd resin dispersion of the present disclosure, as compared to conventional short oil alkyd resin dispersions, may help to improve the performance of the coating layer of the present disclosure. As a result, the aqueous solvent-free short oil alkyd resin dispersion of the present disclosure may permit better corrosion resistance from a coating layer formed with an industrial coating composition that includes the aqueous solvent-free short oil alkyd resin dispersion.

Examples of suitable surfactants' can include, but are not limited to, cationic surfactants, anionic surfactants, or non-ionic surfactants. Examples of anionic surfactants include, but are not limited to, sulfonates, carboxylates, and phosphates. Examples of cationic surfactants include, but are not limited to, quaternary amines. Examples of non-ionic surfactants include, but are not limited to, block copolymers containing ethylene oxide and silicone surfactants.

Various commercially available surfactants may be used in embodiments disclosed herein, including: OP-100 (a sodium stearate), OPK-1000 (a potassium stearate), and OPK-181 (a potassium oleate), each available from RTD Hallstar; UNICID 350, available from Baker Petrolite; DISPONIL FES 77-IS, DISPONIL FES-32-IS, DISPONIL FES-993, and DISPONIL TA-430, each available from Cognis; RHODAPEX CO-436, SOPROPHOR 4D384, 3D-33, and 796/P, RHODACAL BX-78 and LDS-22, RHODAFAC RE-610, and RM-710, and SUPRAGIL MNS/90, each available from Rhodia; E-sperse 100, E-sperse 700, and E-sperse 701 from Ethox Chemical; and TRITON QS-15, TRITON W-30, DOWFAX 2A1, DOWFAX 3B2, DOWFAX 8390, DOWFAX C6L, TRITON X-200, TRITON XN-45S, TRITON H-55, TRITON GR-5M, TRITON BG-10, and TRITON CG-110, each available from The Dow Chemical Company, Midland, Mich.

The surfactant may be partially or fully neutralized with a neutralizing agent. In certain embodiments, neutralization of the surfactant, may be from 25 to 200 percent on a molar basis; or in the alternative, it may be from 50 to 110 percent on a molar basis. For example, for the long chain fatty acid, the neutralizing agent may be a base, such as ammonium hydroxide or potassium hydroxide, for example. Other neutralizing agents can include lithium hydroxide or sodium hydroxide, for example. In another alternative, the neutralizing agent may, for example, be a carbonate. In another alternative, the neutralizing agent may, for example, be any amine such as monoethanolamine, or 2-amino-2-methyl-1-propanol (AMP). Amines useful in embodiments disclosed herein may include monoethanolamine, diethanolamine, triethanolamine, and TRIS AMINO (each available from Angus), NEUTROL TE (available from BASF), as well as triisopropanolamine, diisopropanolamine, and N,N-dimethylethanolamine (each available from The Dow Chemical Company, Midland, Mich.). Other useful amines may include ammonia, monomethylamine, dimethylamine, trimethylamine, monoethylamine, diethylamine, triethylamine, mono-n-propylamine, dimethyl-n propylamine, N-methanol amine, N-aminoethylethanolamine, N-methyldiethanolamine, monoisopropanolamine, N,N-dimethyl propanolamine, 2-amino-2-methyl-1-propanol, tris(hydroxymethyl)-aminomethane, N,N,N′N′-tetrakis(2-hydroxylpropyl) ethylenediamine, 1.2-diaminopropane. In some embodiments, mixtures of amines or mixtures of amines and surfactants may be used. Those having ordinary skill in the art will appreciate that the selection of an appropriate neutralizing agent depends on the specific composition formulated, and that such a choice is within the knowledge of those of ordinary skill in the art.

The aqueous solvent-free short oil alkyd resin dispersion further comprises water. For example, the aqueous solvent-free short oil alkyd resin dispersion of the present disclosure comprises 29 to 65 percent by weight of water, based on the total weight of the dispersion.

For the various embodiments, the percent by weight of the short oil alkyd resin, the surfactant and the water total 100 percent by weight of the aqueous solvent-free short oil alkyd resin dispersion. In embodiments where the aqueous solvent-free short oil alkyd resin dispersion includes one or more additional components as discussed herein the weight percent of each of the additional component(s), the short oil alkyd resin, the surfactant and the water add up to total 100 percent by weight of the aqueous solvent-free short oil alkyd resin dispersion.

The solid particles (e.g., non-volatile dispersed phase in the dispersion) of the short oil alkyd resin in the aqueous solvent-free short oil alkyd resin dispersion have a volume average particle size diameter in the range of from 0.05 to 1.0 μm. All individual values and subranges from 0.05 to 1.0 μm are included herein and disclosed herein; for example, the volume average particle size diameter can be from a lower limit of 0.05, 0.1, 0.2, or 0.5 μm to an upper limit of 0.5, 0.6, 0.7, 0.8, 0.9, or 1.0 μm. In one embodiment, the short oil alkyd resin has a volume average particle size diameter in the range of 0.1 to 0.5 p.m. The volume average particle size diameter is measured as described in the Examples section, below.

The aqueous solvent-free short oil alkyd resin dispersion has a pH in the range of 6 to 10. Other suitable examples of the pH for the aqueous solvent-free short oil alkyd resin dispersion include, for example, the aqueous solvent-free short oil alkyd resin dispersion having a pH value of 4 to 10 or the aqueous solvent-free short oil alkyd resin dispersion having a pH value of 7 to 9.

The aqueous solvent-free short oil alkyd resin dispersion can be produced in a solvent-free process that includes emulsifying the short oil alkyd resin in water with the surfactant, but without a solvent, to produce an emulsified mixture product, where both the short oil alkyd resin and the water are in a liquid state; and cooling the emulsified mixture product to produce the aqueous solvent-free short oil alkyd resin dispersion having 35 to 65 percent by weight of the short oil alkyd resin in a solid state with a volume average particle size diameter in the range of 0.05 to 1.0 μm.

During the emulsifying step, the short oil alkyd resin, in liquid or molten state, is fed into a first mixing device, such as a rotor stator mixer, along with a small amount of water, and optionally a neutralizing agent; and the surfactant. As used, herein, a small amount of water can be from 1 to 50 weight percent of the total weight of the water used in forming the aqueous solvent-free short oil alkyd resin dispersion. It is appreciated that weight percent of water used in forming the emulsion may depend upon the short oil alkyd resin that is present in the emulsifying step.

Bringing the short oil alkyd resin into the liquid or molten state can be accomplished using a melt pot, where the surfactant can optionally be added at this time. As the temperatures required to melt the short oil alkyd resin used in the present disclosure may be greater than 100° C., maintaining the water in the liquid state while forming the emulsion can be accomplished under regulated pressure and temperature. Regulating the temperature and the pressure in this way helps to maintain the water and the short oil alkyd resin in a liquid phase during the emulsification of the short oil alkyd resin. For example, the temperature and the pressure of the rotor stator used in forming the emulsion can be regulated and maintained at a temperature and a pressure that keeps both the short oil alkyd resin and the water of the emulsion in a liquid state. An example of such pressures include those from 2.3 KPa to 1555 KPa. An example of such temperatures include those from 0° C. to 200° C.

The emulsion of the short oil alkyd resin in water with the surfactant produced in the rotor stator mixer can then be cooled by adding a remaining amount of water to the emulsion to achieve the total weight of the water used in forming the aqueous solvent-free short oil alkyd resin dispersion, thereby forming the aqueous solvent-free short oil alkyd resin dispersion of the present disclosure. The remaining amount of water can be added to the emulsion in either a second rotor stator and/or a mixing chamber (e.g., a stir tank) in forming the aqueous solvent-free short oil alkyd resin dispersion of the present disclosure. The remaining amount of water can also be provided at a temperature that helps to both cool and solidify the particles of the short oil alkyd resin from the emulsion formed in the rotor stator. The aqueous solvent-free short oil alkyd resin dispersion can be formed in a batch, a semi-continuous or a continuous process.

A series of two or more rotor stators could be used in producing either the emulsion and/or the aqueous solvent-free short oil alkyd resin dispersion of the present disclosure. Each of the series of two or more rotor stators could be identical machines set to operate in an identical fashion. Alternatively, one or more of the rotor stators could be different machines (e.g., having different rotor and/or stator teeth configurations) operated at different settings (e.g., each operated at a different shear rate and/or temperature), as are known to those skilled in the art.

The present disclosure also includes an industrial coating composition, which is formulated from the aqueous solvent-free short oil alkyd resin dispersion of the present disclosure and a liquid vehicle blended with the aqueous solvent free short oil alkyd resin dispersion. A coating layer can be derived from the industrial coating composition of the present disclosure. For the various embodiments, it is possible that the liquid vehicle can add a solvent to the industrial coating composition. However, as discussed herein, the aqueous solvent-free short oil alkyd resin dispersion does not include a solvent. As such, the aqueous solvent-free short oil alkyd resin dispersion of the present disclosure does not contribute or add solvent to the industrial coating composition. For the various embodiments, the liquid vehicle used in the industrial coating composition can be one or more of a metal containing drier, a nitrogenous hardener such as melamine resin, water, a non-organic solvent, an organic solvent, a co-solvent, a binder composition, a filler, an additive, a pigment, a corrosion inhibitor, a dispersant, a defoamer, a preservative, a thickener, a flow agent, a leveling agent, a neutralizing agent, and combinations thereof.

In one embodiment, the liquid vehicle used in the industrial coating composition is a metal containing drier. Suitable metal containing driers include without limitation, cobalt, zirconium, manganese, calcium, zinc, copper, barium, vanadium, cerium, iron, potassium, strontium, aluminum, bismuth and lithium-containing compounds. The metal containing drier can be present in the range of, for example, from 0.0002 weight percent active metal to 1.0 weight percent active metal, based on the weight of the short oil alkyd resin.

As in the case of polyesters, short oil alkyd resins can be cured via condensation with nitrogenous hardeners such as urea, melamine or polyamides. So, for example, the liquid vehicle used in the industrial coating composition can be a melamine resin. The melamine resin can be present in the industrial coating composition from 5 to 30 weight percent of melamine base on the weight of the short oil alkyd resin.

The industrial coating composition of the present disclosure may also include a blocked isocyanate. When used, the blocked isocyanate could be introduced with the components that are being used to form the aqueous solvent-free short oil alkyd resin dispersion of the present disclosure or after the aqueous solvent-free short oil alkyd resin dispersion has been formed.

The industrial coating composition of the present disclosure can optionally be blended with one or more binder compositions such as acrylic latex, vinyl acrylic latex, styrene acrylic latex, vinyl acetate ethylene latex, and combinations thereof; optionally one or more fillers; optionally one or more additives; optionally one or more pigments, e.g. titanium dioxide, mica, calcium carbonate, silica, zinc oxide, milled glass, aluminum trihydrate, talc, antimony trioxide, fly ash, and clay; optionally one or more dispersants, e.g. aminoalcohols, and polycarboxylates; optionally one or more defoamers; optionally one or more preservatives, e.g. biocides, mildewcides, fungicides, algaecides, and combinations thereof; optionally one or more thickeners, e.g. cellulosic based thickeners such as hydroxyethyl cellulose, hydrophobically modified alkali soluble emulsions and hydrophobically modified ethoxylated urethane thickeners (1-IEUR); optionally one or more flow agents; optionally one or more leveling agents; optionally one or more corrosion inhibitors, or optionally one or more additional neutralizing agents, e.g. hydroxides, amines, ammonia, and carbonates.

The industrial coating composition of the present disclosure can also optionally include a colorant. A variety of colors may be used. Examples include colors such as black, yellow, magenta, and cyan. As a black coloring agent, carbon black, and a coloring agent toned to black using the yellow/magenta/cyan coloring agents shown below may be used. Colorants, as used herein, include dyes, pigments, and pre-dispersions, among others. These colorants may be used singly, in a mixture, or as a solid solution. In various embodiments, pigments may be provided in the form of raw pigments, treated pigments, pre-milled pigments, pigment powders, pigment presscakes, pigment masterbatches, recycled pigment, and solid or liquid pigment pre-dispersions. As used herein, a raw pigment is a pigment particle that has had no wet treatments applied to its surface, such as to deposit various coatings on the surface. Raw pigment and treated pigment are further discussed in PCT Publication No. WO 2005/095277 and U.S. Patent Application Publication No. 20060078485, the relevant portions of which are incorporated herein by reference. In contrast, a treated pigment may have undergone wet treatment, such as to provide metal oxide coatings on the particle surfaces. Examples of metal oxide coatings include alumina, silica, and zirconia. Recycled pigment may also be used as the starting pigment particles, where recycled pigment is pigment after wet treatment of insufficient quality to be sold as coated pigment.

Exemplary colorant particles include, but are not limited to, pigments such as yellow coloring agent, compounds typified by a condensed azo compound, an isoindolynone compound, an anthraquinone compound, an azometal complex methine compound, and an allylamide compound as pigments may be used. As a magenta coloring agent, a condensed azo compound, a diketopyrrolopyrrole compound, anthraquinone, a quinacridone compound, a base dye lake compound, a naphthol compound, a benzimidazolone compound, a thioindigo compound, and a perylene compound may be used. As a cyan coloring agent, a copper phthalocyanine compound and its derivative, an anthraquinone compound, a base dye lake compound, and the like may be used.

The industrial coating composition of the present disclosure can be used to produce a coating layer. In producing the coating layer with the industrial coating composition, the industrial coating composition is provided and applied to a surface of an article or a structure. At least a portion of the water, in addition to any other volatile liquid(s) present in the industrial coating composition, is then removed to produce the coating layer on the surface. In the embodiment where the industrial coating composition includes the metal containing drier the industrial coating composition can undergo autooxidation in forming the coating layer on the surface. In the embodiment where the industrial coating composition includes the melamine resin the industrial coating composition can undergo a thermoset reaction to cross-link the coating layer on the surface.

The industrial coating composition of the present disclosure can be used as one or both of a primer or an industrial paint. The coating layer derived from the industrial coating composition of the present disclosure may be used in different coating applications such as industrial coating applications, automotive coating applications, and outdoor furniture coating applications, among others. It is also possible that the aqueous solvent-free short oil alkyd resin dispersion can be used as an industrial coating composition (e.g., without the liquid vehicle). The coating layer derived from the industrial coating composition can have a variety of thicknesses; for example, such coating layer may have a thickness in the range of from 0.01 μm to 1 mm; or in the alternative, from 1 μm to 500 μm; or in the alternative, from 1 μm to 100 μm; or in the alternative, from 1 to 50 μm; or in the alternative, from 1 μm to 25 μm; or in the alternative, from 1 to 10 μm.

The coating layer formed from the industrial coating composition that include the aqueous solvent-free short oil alkyd resin dispersion can have a gloss of greater than 75 percent; for example greater than 80 percent; or, for example, greater than 85 percent. For example, the gloss may be as high as 90 percent to 100 percent, mostly due to the low amount of surfactant present from the present process. The specified gloss is measured, for example, at 20° on a nonporous substrate like a metal panel. As appreciated by one skilled in the art, gloss can be dependent upon the film thickness of the coating layer formed from the industrial coating composition.

The aqueous solvent-free short oil alkyd resin dispersion and/or the industrial coating composition that includes the aqueous solvent-free short oil alkyd resin dispersion may be applied to one or more surfaces of an article or a structure via a variety of methods. Such methods include, but are not limited to, spraying, dipping, rolling, brushing, and other conventional techniques generally known to those skilled in the art. The aqueous solvent-free short oil alkyd resin dispersion and/or the industrial coating composition may be applied to one or more surfaces of an article or structure at a temperature in the range of greater than about 5° C. Such structures include, but are not limited to, commercial buildings, residential buildings, equipment, metal containers, electrical housing, dumpsters, OEM equipment and warehouses. The surface of such structures to be coated with the aqueous solvent-free short oil alkyd resin dispersion and/or the industrial coating composition may comprise concrete, wood, metal, plastic, glass, drywall, or combinations thereof.

### EXAMPLES

The following examples illustrate the present disclosure but are not intended to limit the scope of the disclosure.

Materials

Sunflower oil (Alnor Oil Co.); Trimethylol propane (TMP, Perstorp Polyols, Inc.); Phthalic anhydride (Nexeo Solutions); Benzoic acid (Acros Organics); Dibutyl tin oxide (Arkema); Monobutyl tin oxide (Arkema); E-SPERSE 100 (liquid, 60% active, Ethox Chemicals); Pentaerythritol (Perstorp Polyols); Isophthalic acid (EASTMAN Chemical); Coconut Fatty Acid (Vantage Oleochemicals); Tall Oil Fatty Acid (Pamolyn 200, Eastman Chemical); PE (pentaerythritol, Perstorp Polyols); TME (trimethylolethane, Geo Specialty Chemicals).

Synthesis of Short Oil Alkyd Resin “404-28”

To form Short Oil Alkyd Resin “404-28,” load 7497 grams (g) of sunflower oil, 6601 g of TMP and 15 g each of dibutyl tin oxide and monobutyl tin oxide (the catalysts) into the reactor and bring the contents up to a temperature of 220° C. Hold the contents at 220° C. for 3 to 16 hours and then cool the contents to 170° C. Once at 170° C., add 7500 g of phthalic anhydride and 1440 g of benzoic acid and bring the contents up to 220° C. Monitor the reaction by collecting samples and measuring the acid value. Once the acid value of 10.4 mg KOH/g is reached remove the Short Oil Alkyd Resin 404-28 from the reactor and cool under a pad of nitrogen. The weight average molecular weight (Mw) for Short Oil Alkyd Resin 404-28 was 6,300 Daltons.

Synthesis of Short Oil Alkyd Resin “404-31”

To form Short Oil Alkyd Resin “404-31,” load 1347.5 grams (g) of sunflower oil, 1237.5 g of pentaerythritol and 550 g of isophthalic acid and 3 g each of monobutyl tin oxide and dibutyl tin oxide (the catalysts) into the reactor and bring the contents up to a temperature of 220° C. Hold the contents at 220° C. for 3 to 16 hours and then cool the contents to 170° C. Once at 170° C., add 825 g of phthalic anhydride and 264 g of benzoic acid and bring the contents up to 220° C. Monitor the reaction by collecting samples and measuring the acid value. Once the acid value of 10.4 mg KOH/g is reached remove the Short Oil Alkyd Resin 404-31 from the reactor and cool under a pad of nitrogen. The weight average molecular weight (Mw) for Short Oil Alkyd Resin 404-31 was 34,800 Daltons.

Synthesis of Short Oil Alkyd Resin “DOE J-6”

Form Short Oil Alkyd Resin “DOE J-6” in a single-stage fatty acid cook procedure as follows. To a reactor add the ingredients and amount shown in the Ingredients Table, below, for DOE J-6. The amounts shown in the Ingredients Table are by weight percent, where the total charge to the reactor constitutes 100 weight percent. Catalyze the reaction by adding 1000 parts per million (ppm) of monobutyltin oxide to the ingredients in the reactor. Close the reactor and purge the atmosphere of the reactor with nitrogen. While stirring heat the contents of the reactor, by electric mantle, to 220° C. Hold the contents at 220° C. for 3 to 16 hours. Water of condensation was distilled from the reaction overhead through a packed column (95° C.) and into a total condenser. Monitor the reaction by collecting samples and measuring the acid value. Once the acid value of 5 mg KOH/g is reached pour the Short Oil Alkyd Resin DOE J-6 from the reactor into a metal can and cool under a pad of nitrogen. The weight average molecular weight (Mw) for Short Oil Alkyd Resin DOE J-6 was 6600 to 13000 Daltons. Final acid value from 5 mg KOH/g to 7 mg KOH/g.

Synthesis of Short Oil Alkyd Resin “DOE J-13”

Form Short Oil Alkyd Resin “DOE J-13” in a single-stage fatty acid cook procedure as discussed above for DOE J-6, with following changes. To the reactor add the ingredients and amount shown in the Ingredients Table, below, for DOE J-11. The weight average molecular weight (Mw) for Short Oil Alkyd Resin DOE J-13 was 9000 to 14000 Daltons. Final acid value from 4 mg KOH/g to 7 mg KOH/g.

Ingredients Table

| | Weight percent | Weight percent |
|---|---|---|
| Ingredient | charged for DOE J-6 | charged for DOE J-13 |
| Isophthalic Acid | 21.4 | 23.3 |
| Phthalic Anydride | 9.2 | 10 |
| Coconut Fatty Acid | 4.6 | 2.3 |
| Tall Oil Fatty Acid | 24.1 | 26.4 |
| Benzoic Acid | 12.2 | 8.2 |
| PE | 11.4 | 6 |
| TME | 17.1 | 23.8 |

### Inventive Example 1

Heat the Short Oil Alkyd Resin 404-28 (solvent-free, acid value 10.4 mg KOH per g of Alkyd Resin) to a temperature of 70° C. overnight to form a molten state. Feed the Short Oil Alkyd Resin 404-28 in the molten state at 15 g/minute (min) and a 28 percent (weight/weight) ammonium hydroxide solution at 0.152 g/min into a rotor-stator mixer. Blend with additional water pumped at a rate of 7.0 g/min and surfactant E-SPERSE 100 (60 percent active in water) pumped at a rate of 1.0 g/min and injected into the rotor stator mixer to create the emulsified mixture product. No solvent is added to create the emulsified mixture product.

The mixer speed was set at approximately 1300 rpm. The number average particle size diameter of the solid content of the emulsion was 0.18 micrometers (μm). The emulsified mixture product has a solid content of approximately 68% percent based on the total weight of the emulsion. To form the aqueous solvent-free short oil alkyd resin dispersion, cool the emulsion by adding water at 23 parts per 100 parts of the emulsified mixture product; thereby forming Inventive Example 1 of the aqueous solvent-free short oil alkyd resin dispersion.

Inventive Example 1 of the aqueous solvent-free short oil alkyd resin dispersion has a solid content of approximately 50 weight percent, 2 percent by weight of the surfactant, based on the total weight of the dispersion, a volume average particle size diameter for the short oil alkyd resin of 0.195 micrometer (μm), a pH of 7.4 and a viscosity of 242 cP (measured by Brookfield viscometer, spindle #1, 20 rpm, 18.3° C.).

### Inventive Example 2

Heat the Short Oil Alkyd Resin 404-31 (solvent-free, acid value 9.4 mg KOH per g of Alkyd Resin) to a temperature of 95° C. overnight to form a molten state. Feed the Short Oil Alkyd Resin 404-31 in the molten state at 15 g/minute (min) and a 28 percent (weight/weight) ammonium hydroxide solution at 0.137 g/min into a rotor-stator mixer. Blend with additional water pumped at a rate of 7.0 g/min and surfactant E-SPERSE 100 (60 percent active in water) pumped at a rate of 1.0 g/min and injected into the rotor stator mixer to create the emulsified mixture product. No solvent is added to create the emulsified mixture product.

The mixer speed was set at approximately 1300 rpm. The number average particle size diameter of the solid content of the emulsion was 0.23 micrometers (μm). The emulsified mixture product has a solid content of approximately 69% percent based on the total weight of the emulsion. To form the aqueous solvent-free short oil alkyd resin dispersion, cool the emulsion by adding water at 30 parts per 100 parts of the emulsified mixture product; thereby forming Inventive Example 2 of the aqueous solvent-free short oil alkyd resin dispersion.

Inventive Example 2 of the aqueous solvent-free short oil alkyd resin dispersion has a solid content of approximately 50 weight percent, 2 percent by weight of the surfactant, based on the total weight of the dispersion, a volume average particle size diameter for the short oil alkyd resin of 0.178 μm, a pH of 7.73 and a viscosity of 242 cP (measured by Brookfield viscometer, spindle #1, rpm, 18.3° C.).

### Stability of Particle Size

A heat age stability test was performed in order to determine changes in the volume average particle size diameter of Inventive Examples 1 and 2. The results of the heat age stability test were that the volume average particle size diameter of Inventive Examples 1 and 2 did not change within the error of the volume average particle size diameter over a 12 week time interval, where the particles were measured every 2 weeks.

Industrial Coating Composition Formulation

An industrial coating composition formulation using the aqueous solvent-free short oil alkyd resin dispersion of. Inventive Example 1 in a clear film and a white pigmented system is listed in Table 1.

Inventive Example 1 and Inventive Example 2 were formulated into Industrial coating composition Formulation Example 1 and Industrial coating composition Formulation Example 2, respectively. The components for the formulations are reported in Table 1. Components 1-5 for each of the formulations are premixed sequentially in container to form premix 1. Premix 1 is mixed via a high speed disperser, and component 6 is gradually added to premix 1 while mixing for approximately 25 minutes at 2500 rpm; thereby forming premix 2. Components 8-10 are sequentially added to premix 2 while mixing at approximately 1200 rpm to form premix 3. Components 10-13 are premixed to form premix 4 via physical shaking in a closed container. Premix 4 is added to premix 3 while mixing continues at approximately 1200 rpm to form final coating composition A. pH of final coating composition A is adjusted to 8.5 with component 14.

TABLE 1

| | | Industrial coating | | | Industrial coating | |
|---|---|---|---|---|---|---|
| | | composition | | | composition | |
| | | Formulation Example 1 | | | Formulation Example 2 | |
| | pH of the Short Oil | | 7.97 | | 7.726 | |
| | Alkyd Resin | | Short Oil Alkyd Resin | | Short Oil Alkyd Resin | |
| | Percent non-volatile | | 404-28, 49.53% | | 404-31, 52.2% | |
| | Short oil alkyd resin | | non-volatile | | non-volatile | |
| Component | Grind paste | Supplier | Amount | Unit | Amount | Unit |
| 1 | Water | | 50 | grams | 50 | grams |
| 2 | RM825 | The Dow | 2 | grams | 2 | grams |
| | | Chemical | | | | |
| | | Company | | | | |
| 3 | Disperbyk 190 | Byk | 7.5 | grains | 7.5 | grams |
| 4 | Triton X-100 | The Dow | 0.5 | grams | 0.5 | grams |
| | | Chemical | | | | |
| | | Company | | | | |
| 5 | Amp-95 (pH 8.5) | Angus | | grams | | grams |
| | | Chemical | | | | |
| 6 | TiO2 | Dupont | 150 | grams | 150 | grams |
| | | Total | 210 | | 210 | |
| | Grind Paste | | 30 | grams | 30 | grams |
| 7 | Short Oil | | Short Oil | grams | Short Oil | grams |
| | Alkyd Resin (g) | | Alkyd Resin | | Alkyd Resin | |
| | | | 404-28, 121.14 | | 404-31, 114.94 | |
| | ADD WHILE MIXING | | | | | |
| 8 | Envirogem AD-01 | Emerald | 0.36342 | grams | 0.34483 | grams |
| | | Performance | | | | |
| | | Chemicals | | | | |
| 9 | Dowanol DPM | The Dow | 1.21139 | grams | 1.14943 | grams |
| | | Chemical | | | | |
| | | Company | | | | |
| 10 | Flash X | Halox | 0.72683 | grams | 0.68966 | grams |
| | | Corporation | | | | |
| 11 | Cobalt Hydrocure | OMG | 1 | grams | 1 | grams |
| | (5% active metal) | | | | | |
| 12 | Zirconium Hydrochem | OMG | 1.5 | grams | 1.5 | grams |
| | (12% active metal) | | | | | |
| 13 | Drier RX | OMG | 0.36342 | grams | 0.34483 | grams |
| | | | 126.3038 | 0.0000 | 119.9713 | 0.0000 |
| 14 | AMP-95 (final pH | Angus | | | | |
| | adjustment to pH 8.5) | Chemical | | | | |

### Comparative Example A and Comparative Example B

Comparative Example A is a commercially available industrial coating composition sold under the trade designator SHER-KEM® (a short oil alkyd high gloss metal finishing enamel, product number F75W200) and commercially available from Sherwin-Williams®. Comparative Example B is a commercially available industrial coating composition sold under the trade designator KEM® 400 Enamel (short oil alkyd, high gloss enamel, product number F75W404) and commercially available from Sherwin-Williams®.

### Performance Results

Performance results of testing the Industrial Coating Composition Formulation (ICCF) Example 1, Industrial Coating Composition Formulation (ICCF) Example 2, Comparative (Comp.) Example A; and Comparative (Comp.) Example B are shown below in Table 2. Comparative Examples A and B are both solvent borne alkyd coatings, whereas Industrial Coating Composition Formulation Example 1 and Industrial Coating Composition Formulation Example 2 of the present disclosure are waterborne systems with less than 50 g volatile organic compound per liter of coating composition (<50 g/L VOC). As seen in Table 2, Industrial Coating Composition Formulation Example 1 and Industrial Coating Composition Formulation Example 2 have better gloss than Comparative Example A and Comparative Example B and similar corrosion resistance.

TABLE 2

| | | | Average | | | | | | | |
|---|---|---|---|---|---|---|---|---|---|---|
| | | | Thickness | | | | 14 day | | | |
| | 7 day | 14 day | (MILS, | 14 day Gloss | | | MEK | Average Initial | | |
| | Average | Average | 0.001 | Average | Average | 14 day | (double | Color | Color | Color |
| | Pendulum | Pendulum | inch) | Gloss 20 | Gloss 60 | Adhesion | rub) | (L*) | (a*) | (b*) |
| ICCF | 5.3 | 14.7 | 44.8 | 85 | 95.8 | 5b | 8 | 92.795 | −0.81 | 5.9 |
| Example 1 | | | | | | | | | | |
| ICCF | 16.7 | 26 | 46.1 | 88.1 | 96.8 | 5b | 25 | 91.755 | −0.795 | 6.345 |
| Example 2 | | | | | | | | | | |
| Comp. | 33.7 | 54 | 36.4 | 86.7 | 94.7 | 5b | 18 | 93.28 | −1.185 | 1.615 |
| Example A | | | | | | | | | | |
| Comp. | 33 | 60.3 | 35.9 | 72.3 | 92.3 | 5b | 15 | 93.27 | −0.905 | 0.09 |
| Example B | | | | | | | | | | |

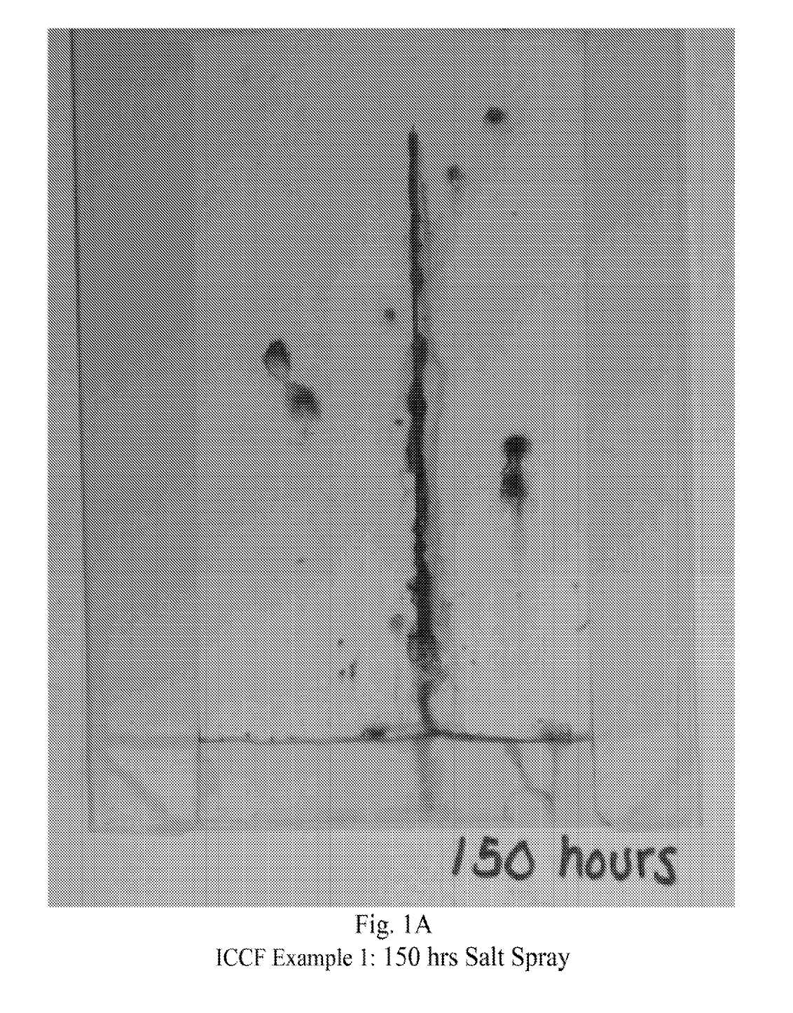

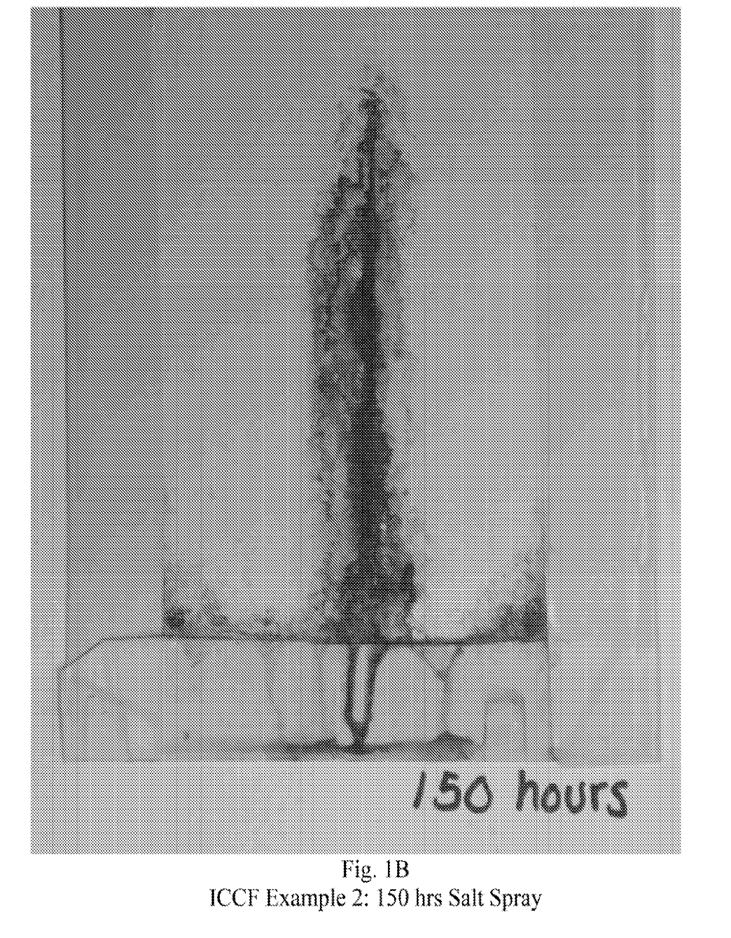

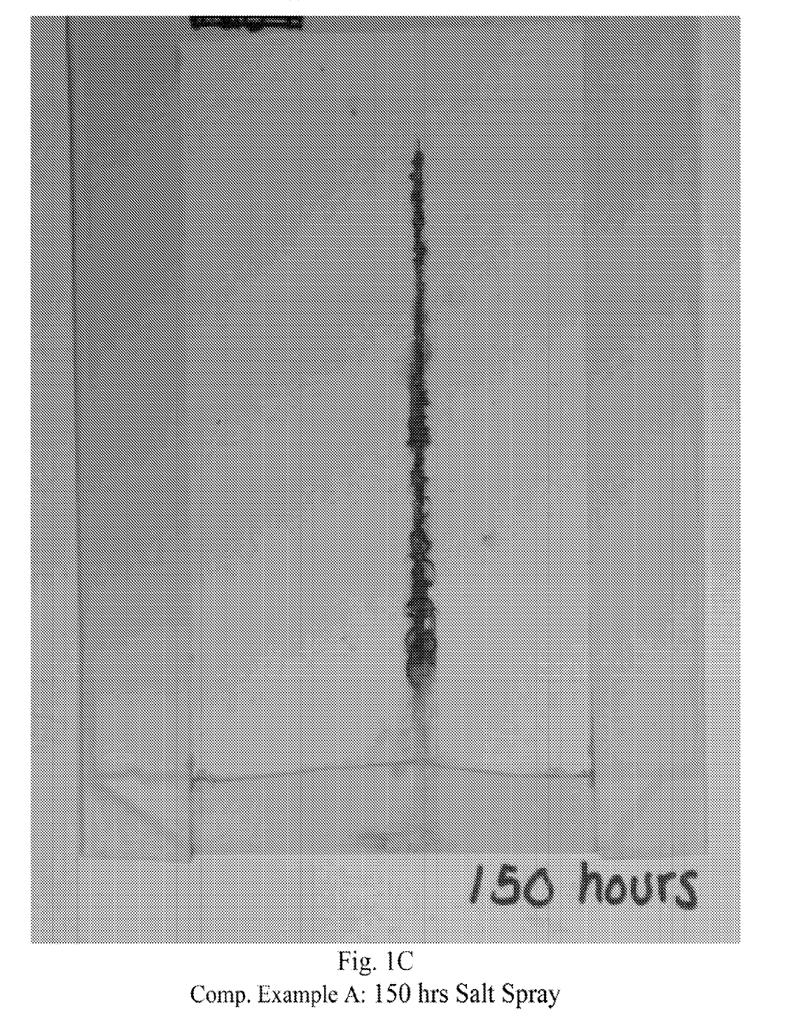

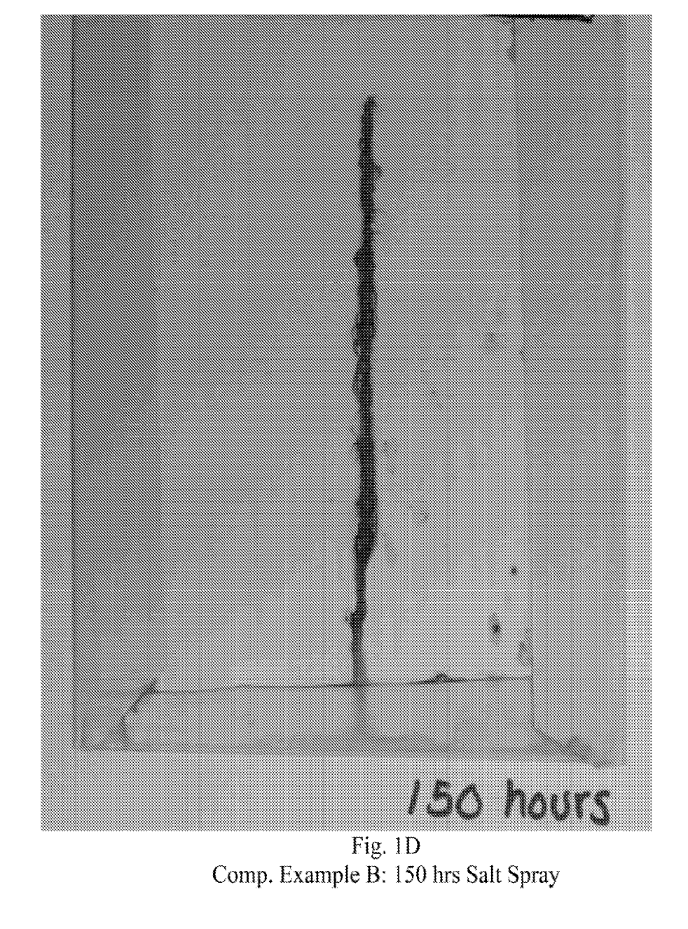

A comparison of the corrosion resistance, after 150 hours in a salt fog cabinet, is shown in FIGS. 1A-1D. FIGS. 1A and 1B show that the coating layer derived from Industrial Coating Composition Formulation Example 1 (FIG. 1A) and the Industrial Coating Composition Formulation Example 2 (FIG. 1B) have similar corrosion resistance to that of the coating layer derived from Comparative Example A and Comparative Example B, both of which are solvent borne systems. This is quite surprising given that waterborne systems typically have worse corrosion resistance due to water sensitivity from the surfactants used to disperse the resin.

Inventive Example 3 and Inventive Example 4 were formulated into Industrial coating composition Formulation Example 3 and Industrial coating composition Formulation Example 4, respectively. The components for the formulations are reported in Table 3. Components 1-4 for each of the formulations are premixed sequentially in container to form premix 1. Premix 1 is mixed via a high speed disperser, and component 5 is gradually added to premix 1 while mixing for approximately 25 minutes at 2500 rpm; thereby forming premix 2. A portion of premix 2 is taken and Components 7-9 are sequentially added to the portion of premix 2 while mixing at approximately 1200 rpm to form premix 3. Components 10-12 are premixed to form premix 4 via physical shaking in a closed container. Premix 4 is added to premix 3 while mixing continues at approximately 1200 rpm to form premix 5. Components 13-15 are added sequentially while mixing continues at 1200 rpm to form the final coating composition B. pH of final coating composition B is adjusted to 8.5 with component 16.

TABLE 3

| | | Industrial coating | | | Industrial coating | |
|---|---|---|---|---|---|---|
| | | composition | | | composition | |
| | | Formulation Example 3 | | | Formulation Example 4 | |
| | pH of the Short Oil | | 7.20 | | 6.90 | |
| | Alkyd Resin | | Short Oil Alkyd Resin | | Short Oil Alkyd Resin | |
| | Percent non-volatile | | DOE J-6, 61.7% | | DOE J-13, 63.8% | |
| | Short oil alkyd resin | | non-volatile | | non-volatile | |
| Component | Grind paste | Supplier | Amount | Unit | Amount | Unit |
| 1 | Water | | 85 | grams | 85 | grams |
| 2 | Byk-1710 | BYK | 2 | grams | 2 | grams |
| 3 | Disperbyk 190 | Byk | 6.5 | grams | 6.5 | grams |
| 4 | Amp-95 (pH 8.5) | Angus | | grams | | grams |
| | | Chemical | | | | |
| 5 | TiPure P-902+ | Dupont | 284 | grams | 284 | grams |
| | | Total | 377.5 | | 377.5 | |
| | Grind Paste | | 79.4 | grams | 79.4 | grams |
| 6 | Short Oil | | Short Oil | grams | Short Oil | grams |
| | Alkyd Resin (g) | | Alkyd Resin | | Alkyd Resin | |
| | | | DOE J-6, | | DOE J-13, | |
| | ADD WHILE MIXING | | 123.99 | | 119.91 | |
| 7 | BYK-348 | BYK | 0.55 | grams | 0.55 | grams |
| 8 | AMP-95 | The Dow | 0.9 | grams | 0.9 | grams |
| | | Chemical | | | | |
| | | Company | | | | |
| 9 | Byk-1710 | BYK | 0.54 | grams | 0.54 | |
| 10 | Borchi Oxy-Coat Drier | Borchers | 0.16 | grams | 0.16 | grams |
| 11 | Cobalt Hydrocure | OMG | 0.40 | grams | 0.40 | grams |
| | (5% active metal) | | | | | |
| 12 | Zirconium Hydrochem | OMG | 1.35 | grams | 1.35 | grams |
| | (12% active metal) | | | | | |
| 13 | BYK-333 | BYK | 0.23 | grams | 0.23 | grams |
| 14 | Crodacor BE-LQ | Croda | 3.9 | grams | 0 | grams |
| (Example 3) | | | | | | |
| 14 | Sodium Nitrite | Fischer | 0 | grams | 1.48 | grams |
| (Example 4) | (15% in H20) | Scientific | | | | |
| 15 | Acrysol RM-8W | The Dow | 2.12 | grams | 2.12 | |
| | | Chemical | | | | |
| | | Company | | | | |
| | | | 134.14 | 0.0000 | 127.64 | 0.0000 |
| 16 | AMP-95 (final pH | Angus | | | | |
| | adjustment to pH 8.5) | Chemical | | | | |

### Performance Results

Performance results of testing the Industrial Coating Composition Formulation (ICCF) Example 3, Industrial Coating Composition Formulation (ICCF) Example 4, and Comparative (Comp.) Example A are shown below in Table 4. Comparative Examples A is a solvent borne alkyd coatings, whereas ICCF Example 3 and ICCF Example 4 of the present disclosure are waterborne systems with less than 50 g volatile organic compound per liter of coating composition (<50 g/L VOC). As seen in Table 4, ICCF Example 3 and ICCF Example 4 have better corrosion resistance, MEK double rub, and 20 and 60 degree gloss than Comparative Example A and similar adhesion, flexibility, and chemical resistance.

TABLE 4

| | Salt | | | | MEK | Visual | | | | | | | |
|---|---|---|---|---|---|---|---|---|---|---|---|---|---|
| | Fog | Undercut | | | Dbl | Impact | 20 | 60 | Early | 50% | Motor | | Formula |
| | Hours | (mm) | Adhesion | Pendulum | Rub | in *lbs | Gloss | Gloss | H2O | EtOH | Oil | NH3 | 409 |
| ICCF | 217 | 0 | 5 | 62 | 19 | 20 | 80 | 93 | 3 | 3 | 4 | 3 | 4 |
| Ex. 3 | | | | | | | | | | | | | |
| ICCF | 217 | 0 (Few field | 5 | 30 | 47 | 20 | 77 | 94 | 3 | 3 | 3 | 4 | 4 |
| Ex. 4 | | blisters) | | | | | | | | | | | |
| Comp | 217 | 3 | 5 | 64 | 14 | 20 | 58 | 90 | 4 | 3 | 4 | 3 | 3 |
| Ex. A | | | | | | | | | | | | | |

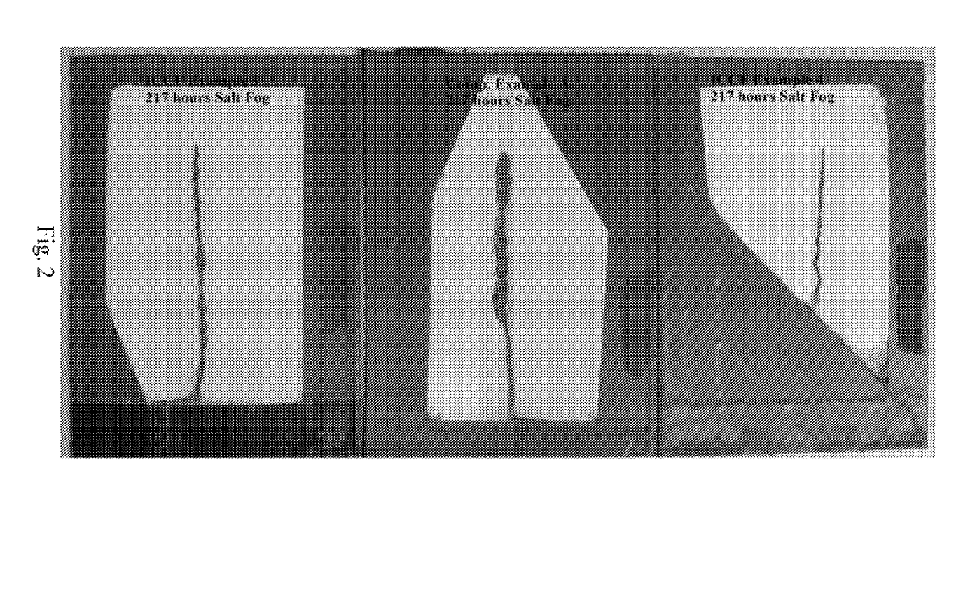

A comparison of the corrosion resistance, after 217 hours in a salt fog cabinet, is shown in FIG. 2. As shown in FIG. 2, the coating layer derived from Industrial Coating Composition Formulation Example 3 (Photograph on Left) and the Industrial Coating Composition Formulation Example 4 (Photograph on Right) have similar corrosion resistance to that of the coating layer derived from Comparative Example A, which is a solvent borne system. This is quite surprising given that waterborne systems typically have worse corrosion resistance due to water sensitivity from the surfactants used to disperse the resin.

### Test Methods

Test methods include the following:

Pendulum Hardness

Pendulum hardness was measured using a Pendulum Hardness Tester from BYK Gardner equipped with a König pendulum. The tester was run according to ISO 1522 and set to measure hardness in seconds. This method evaluates hardness by measuring the damping time in seconds of an oscillating pendulum as its amplitude decreases from 6° to 3°. The pendulum rests with 2 stainless steel balls, 5 mm in diameter, on the coating surface. When the pendulum is set into motion, the balls roll on the surface and put pressure on the coating. Depending on the elasticity of the coating, the damping will be stronger or weaker. If there are no elastic forces, the pendulum will damp stronger. High elasticity will cause weak damping. In other words, the amplitude of the pendulum oscillations decreases more rapidly with softer coatings resulting in shorter damping times.

Film Thickness

Film thickness was measured via a Gardner micro TRI-gloss μ meter.

Corrosion Resistance—Salt Fog Cabinet

Corrosion resistance was tested and measured according to ASTM-B 117-09 Standard Practice for Operating Salt Spray (Fog) Apparatus.

Percent Solids

This method is applicable to the determination of the solids content of alkyd dispersions using the thermogravimetric technique. A moisture analyzer was an Ohaus MB45, available from Ohaus Corporation, Parsippany, N.J. The samples were initially weighed and then dried at 110° C. to remove volatile constituents. The samples were continuously weighed during measurement until the mean weight loss was less than 1 mg in 90 seconds. The solids content is then calculated from the initial and final weights of the sample.

Viscosity

The viscosities of the samples were measured using a Brookfield Programmable DV-II+ Viscometer according to ASTM D2196. Various different spindle sizes were used based on the measuring range of each. The viscosity measurements are reported in units of centipoises (shown as cP). Dispersion retainer samples are collected so that level is adequate to be measured by the RVDV-II+(spring torque 7,187.0 dyne-cm) spindles used by the Brookfield Viscometer.

Gloss

ASTM D-523-89 was used to measure gloss. This procedure covers the measurement of the gloss of coatings at angles of 20°, 60°, and 85° on flat, smooth substrates. This procedure covers the operation of the micro-TRI-gloss meter from BYK Gardner. Gloss is the amount of specular reflection relative to that of a standard surface under the same geometric conditions. Because the gloss of a specimen can vary greatly with the angle of observation, Gloss at angles of 20°, 60°, and 85° degrees are measured.

Color

BYK Spectro-Guide SOP

This procedure is used define the appearance of a coating by simultaneously measuring color and gloss. In order to produce a uniform color coating, both the coating's color and gloss must be controlled since visually the same color with a higher gloss level will be perceived darker and more saturated than the same color at a lower gloss.

The three coordinates of L*, a* and b* represent the lightness of the color (L*=0 yields black and L*=100 indicates diffuse white; specular white may be higher), its position between red/magenta and green (a*, negative values indicate green while positive values indicate magenta) and its position between yellow and blue (b*, negative values indicate blue and positive values indicate yellow).

Adhesion

ASTM D3359-92A is used to measure adhesion.

MEK Double Rub

Solvent Resistance

Test solvent resistance of the Industrial Coating Composition Formulation (ICCF) Example 1, Industrial Coating Composition Formulation (ICCF) Example 2, Comparative (Comp.) Example A, and Comparative (Comp.) Example B, shown in Table 2, according to ASTM D5402 using methyl ethyl ketone (MEK). In this test, a piece of cotton cheesecloth attached to a 1.5 lb. hammer and saturated with MEK is placed on the coating. The hammer is pushed forward and then back in approximately one second (one double rub). The cotton cheesecloth is quickly re-saturated every 25 double rubs. The number of double rubs required to damage the coating and penetrate to the substrate is reported. Higher double rubs indicate better solvent resistance and surface curing.

Acid Value Determination

A 1 to 2 g sample of Short Oil Alkyd Resin 404-28 or Short Oil Alkyd Resin 404-31 was removed from the reactor using a glass pipette and weighed into a 250 mL Erlenmeyer flask. To the flask, 25 mL of 50/50 isopropanol/xylenes mixture was added along with a stir bar. The flask was placed on a stirrer/hot plate and allowed to mix with gentle heating until the material was dissolved. Then, a few drops of phenolphthalein indicator solution were added to the flask and the contents titrated to the phenolphthalein endpoint using 0.1N potassium hydroxide in methanol. The AV was then calculated according to the following formula:

$$AV = \frac{mL titrant \times 56.1 \times normality of titrant}{sample weight in grams}$$

Volume Average Particle Size Diameter

Particle Size Analyzer

A Beckman Coulter LS 13-320 particle size analyzer was used with a Universal Liquid Module as the sample delivery system. The instrument conforms to the ISO 13-320 standard. The software version utilized was Version 6.01. Hardware and software were obtained from Beckman Coulter Inc., Miami, Fla.

The analysis conditions for all measurements used a fluid refractive index of 1.332, a sample real refractive index of 1.5, and a sample imaginary refractive index of 0.0. The extended optical model was not employed. The polarization intensity differential scattering (PIDS) option was activated and used to generate the particle size information. The volume average particle size diameter was measured and reported in μm. A Coulter LATRON™ 300 LS latex standard was used to calibrate the particle size analyzer.

Heat Age Stability is determined by re-measuring (after a specified temperature and time cycle) the particle size and solids content of the dispersion to determine if a change has occurred. The dispersion samples were placed in a glass jar with a plastic lid. The jar was placed inside an oven set at a temperature of 50° C. and allowed to sit for 12 weeks. The particle size was measured using the same procedure as outlined previously every 2 weeks during this 12 week time interval.

Weight Average Molecular Weight

Measure weight average molecular weight and polydispersity by gel permeation chromatography (GPC) on an Agilent 1100 series LC system equipped with an Agilent 1100 series refractive index detector. Dissolve samples in HPCL grade THF at a concentration of approximately 1 mg/mL and filter through at 0.20 μm syringe filter before injection through the two PLGeI 300×7.5 mm Mixed-C columns (5 mm, Polymer Laboratories, Inc.). Maintain a flow rate of 1 mL/min and temperature of 35° C. Calibrate the columns with narrow molecular weight PS standards (EasiCal PS-2, Polymer Laboratories, Inc.).

Acid Value

Perform acid value (AV) according to standardized methods. Perform the AV on a weighed sample of resin fully dissolved in solvent (isopropanol/xylenes 50/50) and titrated to a phenolphthalein endpoint using KOH per ASTM D1639.

1. An aqueous solvent-free short oil alkyd resin dispersion comprising:
35 to 65 percent by weight of a short oil alkyd resin based on the total weight of the dispersion, where the short oil alkyd resin has a weight average molecular weight (M_{w}) in the range of 5,000 to 5,000,000 Dalton and a volume average particle size diameter in the range of 0.05 to 1.0 μm;
0.1 to 6 percent by weight of a surfactant, based on the total weight of the dispersion; and
29 to 65 percent by weight of water, based on the total weight of the dispersion, where the aqueous solvent-free short oil alkyd resin dispersion does not include a solvent.

2. The aqueous solvent-free short oil alkyd resin dispersion of claim 1, where the short oil alkyd resin is characterized by one of the following properties (a) a weight average molecular weight (M_{w}) in the range of 1,000,000 to 5,000,000 Dalton; (b) a volume average particle size diameter in the range of 0.1 to 0.5 μm; (c) 2 to 4 percent by weight of the surfactant, based on the total weight of the dispersion; (d) an acid value of no greater than 20 mg of KOH per gram of the short oil alkyd resin; or (e) a combination thereof.

3. The aqueous solvent-free short oil alkyd resin dispersion of claim 1, where the short oil alkyd resin has an oil length of 1 to less than 40 weight percent oil.

4. The aqueous solvent-free short oil alkyd resin dispersion of claim 1, where the aqueous solvent-free short oil alkyd resin dispersion has a pH value of 7 to 9.

5. The aqueous solvent-free short oil alkyd resin dispersion of claim 1, where the aqueous solvent-free short oil alkyd resin dispersion has a viscosity in the range of 100 cP to 10,000 cP measured at 18° C.

6. A solvent-free process for producing an aqueous solvent-free short oil alkyd resin dispersion, comprising:
emulsifying 35 to 65 percent by weight of a short oil alkyd resin based on the total weight of the dispersion, where the short oil alkyd resin has a weight average molecular weight (M_{W}) in the range of 5,000 to 5,000,000 Dalton and a volume average particle size diameter in the range of 0.05 to 1.0 μm in 29 to 65 percent by weight of water, based on the total weight of the dispersion, with 0.1 to 6 percent by weight of a surfactant, based on the total weight of the dispersion, but without a solvent, to produce an emulsified mixture product, where both the short oil alkyd resin and the water are in a liquid state; and
cooling the emulsified mixture product to produce the aqueous solvent-free short oil alkyd resin dispersion.

7. The solvent-free process of claim 6, including maintaining the water in the liquid state by regulating a temperature and a pressure of the water during the emulsifying of the short oil alkyd resin.

8. The solvent-free process of claim 6, including providing 0.1 to 6 percent by weight of the surfactant to the emulsified mixture product.

9. An industrial coating composition, comprising:
an aqueous solvent-free short oil alkyd resin dispersion having:
35 to 65 percent by weight of a short oil alkyd resin based on the total weight of the dispersion, where the short oil alkyd resin has a weight average molecular weight (M_{w}) in the range of 5,000 to 5,000,000 Dalton and a volume average particle size diameter in the range of 0.05 to 1.0 μm;
0.1 to 6 percent by weight of a surfactant, based on the total weight of the dispersion; and
29 to 65 percent by weight of water, based on the total weight of the dispersion, where the aqueous solvent-free short oil alkyd resin dispersion does not include a solvent; and
a liquid vehicle with which the aqueous solvent-free short oil alkyd resin dispersion is blended.

10. The industrial coating composition of claim 9, where the liquid vehicle is a metal containing drier.

11. The industrial coating composition of claim 9, where the liquid vehicle is a melamine resin.

12. A coating layer derived from the industrial coating composition of claim 9.
